(19) United States
(12) Patent Application Publication
(10) Pub. No.: US 2008/0067821 A1
(43) Pub. Date: Mar. 20, 2008

(54) Method and Apparatus for Minimizing Damage to Vehicles Due to Impact

(76) Inventor: Dennis Mraz, Sunny Isles, FL (US)

Correspondence Address: GREENBERG & LIEBERMAN, LLC, 2141 WISCONSIN AVE, N.W., SUITE C-2, WASHINGTON, DC, 20007, US

(21) Appl. No.: 11/532,228

(22) Filed: Sep. 15, 2006

(51) Int. Cl. B60R 19/20

(52) U.S. Cl. 293/107

(57) ABSTRACT

A vehicle bumper is constructed of an inflatable bladder that absorbs impact energy and provides increased protection to the vehicle and its occupants. The bumper deflates upon impact and is capable of quickly restoring to its original shape and appearance by re-inflating.

This is a nonprovisional of provisional patent application No. 60/593,708 filed on Feb. 07, 2005 and priority is claimed thereto.

### FIELD OF INVENTION

The present invention generally relates to automobiles and more specifically to impact absorbing devices in automobiles.

### BACKGROUND OF THE INVENTION

At present, automobiles are equipped with front and rear bumpers. These bumpers are located in the areas of a vehicle that are most frequently subjected to impacts caused by accidents. Bumpers are designed to minimize the damage from accidents and are often constructed of elastomeric materials that have the capability to collapse upon impact and rebound afterwards. Unfortunately, the amount of the impact energy absorbed by present bumpers is minimal. To overcome this shortcoming, various system have been proposed for absorbing kinetic energy in vehicle bumpers. For example U.S. Pat. No. 6,435,578 to Li discloses an energy dissipater filled with oil which is attached to the bumper. U.S. Pat. No. 6,572,162 to Belloso discloses elongated, force transmitting members which attach the front and rear bumpers to energy-absorbing springs. Similarly, U.S. Pat. No. 6,709,035 to Namuduri at al. discloses an automobile bumper attached to a lead screw engaged with a nut, which allows the bumper to retract on impact. These and other proposed devices are relatively complex and may require costly resetting after the impact. Therefore, it is desirable to have a bumper that is capable of absorbing relatively high levels of impact energy while providing better protection to the vehicle and its occupants. It is also desirable to have a bumper that will not be appreciably damaged by an accident and that is capable of being quickly restored to its original shape and appearance.

### SUMMARY OF THE INVENTION

Accordingly, it is the object of the present invention to provide a method and apparatus for absorbing kinetic energy in vehicle bumpers that will minimize damage to the vehicle and to the bumper.

Another object of the present invention is to provide an energy-absorbing bumper that is simple and easy to manufacture.

Another object of the present invention is to provide a bumper that can be quickly and easily restored to its pre-impact functionality.

Another object of the present invention is to provide a bumper that can be quickly and easily restored to its pre-impact appearance.

### BRIEF DESCRIPTION OF THE DRAWINGS

FIG. 1 is a side view of a typical automobile with the proposed inflatable bumpers at the front and rear of the vehicle.

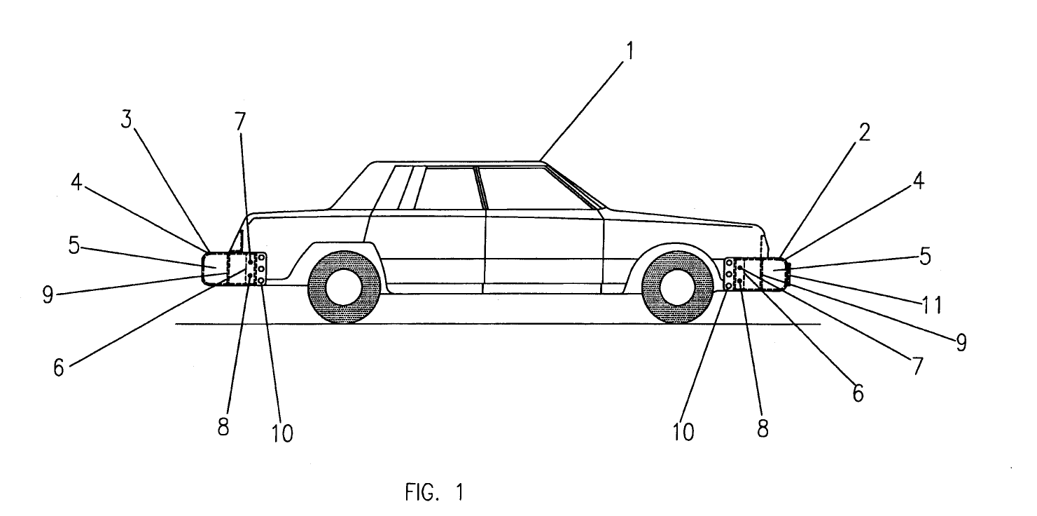

FIG. 2 is a front view of the typical automobile shown in FIG. 1.

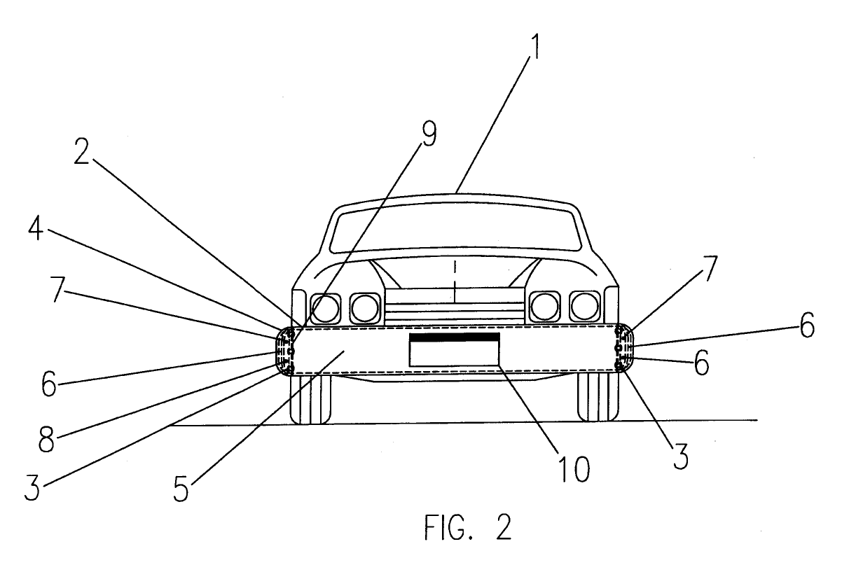

### DETAILED DESCRIPTION OF THE PREFERRED EMBODIMENT

Referring to FIG'S. 1 and 2, the front inflatable bumper (2), and the rear inflatable bumper (3), are mounted on vehicle (1). The inflatable bumpers (2) and (3) consist of flexible inflatable chambers (4), containing pressurized medium (5). The pressurized medium (5) is introduced into the inflatable chambers (4) through the inflation valves (7) located within the reinforced parts (6) of said inflatable chambers (4). Pressure relief valves (8) are also located within the reinforced parts (6) of the inflatable chambers (4). The inflatable bumpers (2) and (3) are mounted on the mounting plates (9) of the vehicle (1) by fasteners (10). The inflatable bumpers (2) and (3) may also contain a molding (11) for mounting of a license plate.

When vehicle (1) is struck due to a collision within the area of the inflatable bumper (2) or (3), the force of the impact causes a compression of the inflatable chamber (4) and an increase of the pressure of the pressurized medium (5). When the pressure of the pressurized medium (5) exceeds a certain predetermined value, the pressurized medium (5) begins escaping to the atmosphere through the pressure relief valve (8), causing a gradual deflation of the inflatable chambers (4). A gradual deflation of the inflatable chamber (4) reduces the deceleration or acceleration forces acting upon vehicle (1) and its contents, including the passengers. The original shape and function of the inflatable bumpers (2) and (3) can be restored by re-inflating the inflatable chambers (4) through the inflation valves (7).

In the preferred embodiment, the inflatable bumpers (2) and (3) have an appearance of a standard car bumper when it is inflated with the filling medium (5) to a desired pressure. The presurized medium (5) is introduced into the inflatable chamber (4) through the inflation valves (7). When the inflatable bumper (2) or (3) is impacted by a collision with an obstacle or with another vehicle, the force of the impact causes the pressure of the pressurized medium (5) to increase beyond the desired level. The increased pressure of the filling medium (5) causes the filling medium (5) to gradually exit through the pressure relief valve (8) into the atmosphere, which in turn deflates the inflatable chamber (4) at the rate proportional to the impact force. This allows a controlled deceleration of the vehicle (1), which in turn minimizes damage to the vehicle (1) and the passengers. Additionally, because of the ability of the inflatable chamber (4) to deflate and inflate repeatedly, damage to the inflatable bumper (2) or (3) is likely to be avoided or at least minimized.

In an alternative embodiment, said inflatable chamber (4) is filled with a fire retardant medium and said pressure relief valve (8) is directed toward a flammable area of the vehicle such as the gas tank. If the inflatable bumper is impacted, said flame retardant medium is directed in such a way as to coat the flammable area with the fire retardant medium and minimize the possibility of fire.

In yet another alternative embodiment, the inflatable bumper may be shaped as any other part of a vehicle, such as a panel of a car door, in order to minimize the damage from impact to the side or another part of a vehicle.

In another alternative embodiment, the gas tank may be constructed, at least in part, of an inflatable chamber that can absorb the impact and release fire retardant material, in order to prevent fire or, at least, minimize its spreading.

In yet another embodiment, the inflatable chamber may be filled with liquid, such as water, silicon jelly or other gaseous or liquid substances.

The foregoing preferred specific embodiments have been shown and described for the purpose of illustrating the functional and structural principles of this invention and are subject to change without departure from such principles. Therefore, this invention includes all modifications encompassed within the spirit and scope of the following claims.

What is claimed is:

1. An impact damage reduction method for a vehicle, comprising:
providing at least one inflatable bumper on said vehicle;
setting a pressure relief means provided in said inflatable bumper to a predetermined level of pressure;
inflating said inflatable bumper with a pressurized medium; and
deflating said inflatable bumper upon impact at a rate consistent with a desired acceleration or deceleration.

2. The impact damage reduction method claim 1, wherein said inflatable bumper is made of an elastic material.

3. The impact damage reduction method of claim 1, wherein said pressurized medium is air.

4. The impact damage reduction method of claim 1, wherein said pressurized medium is water.

5. The impact damage reduction method of claim 1, wherein said pressure relief means is a pressure relief valve.

6. The impact damage reduction method of claim 5, wherein at least one outlet from said pressure relief valve is directed towards the flammable parts of a vehicle and said pressurized medium is a fire suppressing agent.

7. An inflatable bumper, comprising:
A base plate fastened to the frame of a vehicle;
An inflatable chamber;
An inflation valve;
A pressure relief valve; and
A pressurized medium.

8. The inflatable bumper of claim 7, wherein said inflatable chamber is made of elastic material.

9. The inflatable bumper of claim 7, wherein said pressure relief valve includes outlets for directing said pressurized medium towards the flammable parts of a vehicle and said pressurized medium is fire suppressing agent.

10. The inflatable bumper of claim 9, wherein said pressure relief valve outlets are directed towards a fuel tank.

11. An inflatable bumper, comprising:
A base plate fastened to the frame of a vehicle;
An inflatable chamber;
An inflation valve; and
A pressurized medium.

12. The inflatable bumper of claim 11, wherein said inflatable chamber is made of elastic material.

13. The inflatable bumper of claim 11, wherein said pressure relief valve includes outlets for directing said pressurized medium towards the flammable parts of a vehicle and said pressurized medium is fire suppressing agent.

14. The inflatable bumper of claim 13, wherein said pressure relief valve outlets are directed towards a fuel tank.

15. The inflatable bumper of claim 11, wherein said pressurized medium is an elastic, pressurized solid or foam, compressible at a predetermined rate.
